(19) United States
(12) Patent Application Publication
(10) Pub. No.: US 2002/0000290 A1
(43) Pub. Date: Jan. 3, 2002

(54) Curing of a gel coat on a mold

(76) Inventors: Larry Scott Crump, Gladstone, MO (US); Therese E. Feess, Mission, MO (US); Erwoan Pezron, Prairie Village, MO (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/681,803

(22) Filed: Jun. 7, 2001

Related U.S. Application Data
(60) Provisional application No. 60/215,058, filed on Jun. 29, 2000.

(51) Int. Cl. B29C 47/00

(52) U.S. Cl. 156/245; 156/275.5

(57) ABSTRACT

Partially cured gel coats are prepared in a manner for subsequent application to a substrate, e.g. a reinforcing polymer matrix, by a process comprising the steps of: A. Applying a gel coat, e.g., an unsaturated polyester resin, to a nonporous mold, e.g., a polyester film, which is at least partially transparent to actinic radiation, e.g. UV light; and B. Exposing the surface of the gel coat that is in contact with the film, i.e., the bottom surface, to actinic radiation that has first passed through the mold. In certain embodiments of the invention, the surface of the gel coat opposite the bottom surface, i.e., the top surface, is exposed to actinic radiation shortly after the bottom surface is exposed to the actinic radiation to effect a bi-directional cure of the gel coat. The gel coat produced by the process of the invention is nonporous and essentially defect-free.

### BACKGROUND OF INVENTION

This invention relates to gel coats. In one aspect, this invention relates to gel coats cured on a mold, particularly a film substrate, while in another aspect this invention relates to gel coats cured by actinic radiation. In yet another aspect, this invention relates to gel coats having at least one nonporous surface.

As here used, gel coat means any polymer or resin that is (i) curable by actinic radiation, (ii) free of reinforcing material, (iii) used as an interior and/or exterior surface for a manufactured product, and (iv) fabricated by application to a rigid open or closed mold or flexible film. Typically the gel coat is laminated to a reinforced polymer matrix. For example, in the conventional process for forming fiber reinforced plastic boat hulls or cultured marble vanities, a first layer of polymer that is free of reinforcing fiber (i.e., the gel coat) is applied to the inside surface of a female mold and partially or fully cured, a second layer of polymer (which can be the same as or different from the gel coat polymer) containing reinforcing fiber (e.g., fiberglass, plastic fibers, etc.) is applied to the exposed surface of the first layer, and the joined layers are then fully cured. The purpose of the gel coat is to provide the manufactured article, e.g., the boat hull, vanity, etc., with an aesthetically attractive exterior surface that is resistant to environmental abuse, e.g., oxidation, scratches, organic solvents, water, etc.

Gel coats can and often are used in combination with materials other than reinforced polymer matrices. For example, gel coats can be applied to wood, paper, metal, cut stone, nonreinforced plastics (i.e., plastics without a reinforcing substance, e.g., fiberglass) and ceramics. Application of a gel coat to these materials may or may not require (or permit) the use of a mold. Often the gel coat is simply sprayed or otherwise applied to the surface of the substrate and then cured. One drawback of this procedure is that it usually produces a gel coat with an exposed surface having a low gloss, i.e., the surface of the gel coat that is open to the environment (or in other words, the surface of the gel coat that is opposite the surface in contact with the substrate).

The application and cure of a conventional gel coat which is based on unsaturated polyester resins diluted in styrene, methyl methacrylate or other rapidly evaporating monomers and solvents, typically results in the evolution of one or more volatile compounds, i.e., volatiles. These volatiles are released to the environment through evaporation during (i) the application of the gel coat onto the mold or substrate, and (ii) during the cure of the gel coat film.

Gel coats are coatings based on thermosetting polymers which cure via free radical polymerization. Gel coats have been cured using two types of free radical initiating systems, i.e., (i) room temperature oxidation-reduction initiating systems which are commonly based on the use of a transition metal and a ketone peroxide (such as methyl ethyl ketone peroxide, 2,4-pentanedione peroxide, or methyl isobutyl ketone peroxide) or hydroperoxide (such as cumyl hydroperoxide), or (ii) a thermal initiating system commonly based on the use of diacyl peroxides, peroxyesters, peroxyketals or peroxydicarbonates.

Gel coats cured via room temperature oxidation-reduction initiating systems cure at an uneven rate in the depth direction of the film (i.e., surface to center). The gel coat cure is inhibited at the air/coating interface due to the chemical inhibiting effect of oxygen on the free radical polymerization process. As a result, the gel coat cures more rapidly at the mold/coating interface than at the air/coating interface. This phenomena is known as a cure gradient. It may also be present in thermal initiated cure systems, but usually to a lesser degree. If not properly controlled, a cure gradient can lead to one or more of three well-recognized problems in the cured gel coat, i.e., porosity, warpage and/or alligatoring.

Porosity is a common problem with gel coat films, and it is the result of entrapped air in the wet, i.e., uncured, gel coat film (which was likely introduced during application). If the air is not released at the air/coating interface, then it will likely remain trapped in the cured film and result in void defects (i.e., porosity). Since the gel coat polymer undergoes a reduction in volume during polymerization, the cure gradient produces a natural mechanism during the film cure to expel the entrapped air away from the mold-coating interface and towards the air-coating interface. This, however, works only if the that part of the gel coat that interfaces with air has not yet cured (and thus blocking escape of the entrapped air). If trapped, then the air will cause visible defects to the cosmetic surface of the coated article, i.e., the surface of the coating which was in contact with the mold prior to its removal from the mold. A void free coating at the mold/coating interface has great consequence to the aesthetic appearance and protective properties of the cured gel coat.

Warpage of a gel coat may also result from an uncontrolled cure gradient. Warpage is typically manifested in a curling of one or more edges of the gel coat upon cure, the result of the edges curing more quickly than the body of the gel coat.

Alligatoring is yet another problem that a gel coat can suffer as a result of an uncontrolled cure gradient. Alligatoring is a wrinkling of the gel coat that resembles an alligator hide, and it results from an uneven cure, typically in the thickness direction of the gel coat. Alligatoring greatly detracts from the aesthetic appearance of the cured gel coat surface.

Gel coats cured in an oven, autoclave, or with infrared lamps using thermally initiated systems cure much more uniformly in the depth direction of the film, but generally are more porous due to the entrapment of air as well as the generation of bubbles which results from heating the volatile organic compounds present in the coating. Warpage and alligatoring are also possible from this type of cure, although these problems are more susceptible to control because the cure gradient resulting from this type of cure is more susceptible to control.

Methods of applying a nonporous gel coat to a substrate in a more efficient manner remain of interest to those practicing in this art.

### SUMMARY OF INVENTION

In one embodiment of this invention, a nonporous gel coat is at least partially cured by a process comprising the steps of:

A. Applying an uncured gel coat to a nonporous mold, the mold at least partially transparent to actinic radiation, the uncured gel coat (i) comprising a polymeric composition that cures upon exposure to actinic radiation, and (ii) having a first surface in contact with a surface of the nonporous mold, and a second surface opposite the first surface and open to the environment; and

B. Exposing the first surface of the uncured gel coat to actinic radiation from a source located such that the actinic radiation must pass through the nonporous mold to effect an at least partial cure of the gel coat.

In another embodiment of this invention, a nonporous gel coat is at least partially cured by a bi-directional curing process comprising the steps of:

A. Applying an uncured gel coat to a nonporous mold, the mold at least partially transparent to actinic radiation, the uncured gel coat (i) comprising a polymeric composition that cures upon exposure to actinic radiation, and (ii) having a first surface in contact with a surface of the nonporous mold, and a second surface opposite the first surface and open to the environment;

B. Exposing the first surface of the uncured gel coat to actinic radiation from a first source, the first source located such that the actinic radiation must pass through the nonporous mold to effect an at least partial cure of the gel coat; and

C. Simultaneously or shortly following step (B), exposing the second surface of the gel coat to actinic radiation from a second source, the second source of the actinic radiation located such that the actinic radiation does not pass through the nonporous mold to effect the at least partial cure of the gel coat.

In other embodiments of this invention, the nonporous, transparent mold is a film, and the actinic radiation is at least one of IR, visible light and UV light. In still other embodiments, the partially cured gel coat is sandwiched between the top and bottom surfaces of the nonporous, transparent film, or sandwiched between the top surface of the nonporous film and the bottom surface of a cover film and collected onto a take-up reel for transport and storage.

The curing configurations of this invention will also cause the cure gradient that was described above for the room temperature oxidation-reduction initiation system. The result is a gel coat with a nonporous surface (i.e., the surface that was in contact with the mold surface) with excellent protective and aesthetic properties.

For those applications in which the gel coat cure cannot be initiated from a rigid, nonporous mold surface for whatever reason, the production of a nonporous, exposed surface is usually accomplished by one of two processes. In one process, i.e., contemporaneous processing, an uncured gel coat layer is applied to a nonporous material, e.g., a nonporous plastic film, and then a cure is initiated through the film by actinic radiation from a source located beneath the bottom surface of the film. This is followed, usually immediately, by curing the top, exposed surface using actinic radiation to complete the cure of the gel coat. The cured gel coat may then be laminated using a variety of processes including, but not limited to, hand lay-up, resin transfer molding (RTM), resin-infusion molding, etc. For this process, the coating application, coating cure and lamination application and cure occur relatively contemporaneously (i.e., within a short time span of a one another, typically within less than a few hours) and as such, no intermediate storage of the at least partially cured coating is required.

A second process, noncontemporaneous processing, is to prepare an at least partially cured gel coat separate and apart from the substrate, and then to apply a laminate to the coating. The coating may be stored as a cured film in sheet form or on a roll. The coating may then be used at a later date to fabricate a composite part by applying a laminate to the coating. Using this noncontemporaneous process, a layer of uncured gel coat is applied to a nonporous, transparent film. On the top, exposed surface of the gel coat, a cover film is applied, e.g., Mylar®, polystyrene, a surface veil (e.g., silica glass). The cure is then initiated from beneath the bottom surface of the first transparent film by actinic radiation. This is immediately followed by exposing the top surface of the second film to actinic radiation to the complete the cure of the gel coat. The cured gel coat is then taken up onto a roll, ready for storage and shipment, or stored in sheet form. The gel coat can be used by unrolling the gel coat onto the substrate, removing the remaining film, and applying the laminate. The gel coat can be laminated to the substrate with or without the aid of an adhesive.

A slight variation to the noncontemporaneous process is to apply a layer of uncured gel coat to a nonporous, transparent film and initiate cure through the bottom of the film by actinic radiation. This is immediately followed by exposing the top surface to actinic radiation to complete the cure of the gel coat. At this point, a second film that is soluble in laminating resin is applied to the top surface and the cured gel coat is taken up onto a roll and ready for storage and shipment, or stored in sheet form. The gel coat can be laminated to the substrate with or without the aid of an adhesive.

### BRIEF DESCRIPTION OF DRAWINGS

FIG. 1 is a schematic depiction of a production line for the contemporaneous processing of a gel coat on a plastic film in which a gel coat resin is (i) applied to a nonporous, transparent film, (ii) bi-directionally cured, (iii) optionally laminated to a reinforced polymer matrix, and (iv) taken up on a roll.

FIG. 2a is a partial depiction of FIG. 1 showing the UV mercury lamps in a staggered but overlapping configuration.

FIG. 2b is a partial depiction of a variant of FIG. 1 in which the UV mercury lamps depicted in detail in FIG. 2a are replaced with UV mercury lamps that reciprocate such that the entire width of the gel coating on the casting film is exposed to a curing amount of UV radiation from both below and above the film.

FIG. 3a is a schematic depiction of a production line for the noncontemporaneous processing of a gel coat on a plastic film in which a gel coat resin is (i) applied to a nonporous, transparent film, (ii) covered with a second nonporous, transparent film, (iii) bidirectionally cured, and (iv) taken up on a roll.

FIG. 3b is a schematic depiction of a production line for the noncontemporaneous processing of a gel coat on a plastic film in which a gel coat resin is (i) applied to a nonporous, transparent film, (ii) bi-directionally cured, (iii) covered with a second film, and (iv) taken up on a roll.

### DETAILED DESCRIPTION

Any known gel coat resin that can be cured by actinic radiation can be used in the practice of this invention. The gel coat resins described in U.S. Pat. Nos. 4,543,366, 5,028,459 and 4,664,982, all of which are incorporated herein by reference, are illustrative.

Preferred resins include unsaturated polyester resins based on neopentyl glycol and isophthalic acid. Other gel coats include vinyl esters, epoxies, acrylics and urethane acrylates, although these tend to be more expensive than those based upon unsaturated polyesters. In applications in which moisture resistance is not of prime importance, orthophthalic acid based resins can be used.

Conventional room temperature cured gel coats (oxidation-reduction systems as described above) are typically applied to a film thickness of about 0.5 mm. If a liquid layer of this thickness is applied to a mold surface that is not horizontal in orientation, then the gel coat should be shear thinning. In other words, the viscosity of the gel coat should be relatively low during application by spraying, brushing, rolling or other means, but otherwise sufficiently high to resist gravity as soon as the application procedure stops.

The gel coat, whether clear or pigmented, is cured by exposure to actinic radiation. As here used, actinic radiation includes any form of electromagnetic radiation from very low frequency radio waves through infrared (IR), visible light, ultraviolet light (UV), x-rays and gamma rays. As a practical matter, IR, visible and UV radiation are preferred with UV radiation most preferred. In addition, the cure of the gel coat can be augmented with thermal energy (including that which is naturally associated with the use of radio frequency and IR radiation).

Although not required, photoinitiators are often employed to promote a fast and efficient cure. Any of the known initiators can be used in the practice of this invention and, of course, the initiators are matched with the form of energy used to effect the cure. If UV light is used to effect the cure, representative photoinitiators include organic carbonyl compounds such as benzophenone, benzanthrone, benzoin and alkyl ethers thereof, 2,2-diethoxyacetophenone, 2,2-dimethoxy-2-phenylacetophenone, p-phenoxy dichloroacetophenone, 2-hydroxycyclohexylphenone, 2-hydroxyisopropylphenone, 1-phenyl propanedione-2-(ethoxycarboxyl)oxime, monoacyl phosphine oxides, bisacyl phosphine oxides and 2,4,6-trimethylbenzoyldiphenylphosphine oxide.

If the cure is augmented with thermal energy, any known peroxide catalyst can be incorporated into the gel to accelerate the cure. A preferred peroxide catalyst is 2,5-dimethyl-2,5-bis(2-ethylhexanoylperoxy) hexane commercially available under the trademark Lupersol® 256 from Pennwalt Corporation. Other peroxides or hydroperoxides such as methyl ethyl ketone peroxide, benzoyl peroxide, cumene hydroperoxide, and any of the various peroxyesters or the like can be used.

Metallic driers or copromoters may also be used to assist in the curing. Especially effective are cobalt-based driers such as cobalt octoate and cobalt napthenate or complexes of cobalt and potassium organo compounds. Solvents may be added to the gel coat to reduce viscosity, and additives such as fluorocarbons, silicates, cellulose acetate butyrate, and the like may be added to control flow, leveling, thixotrophy and viscosity.

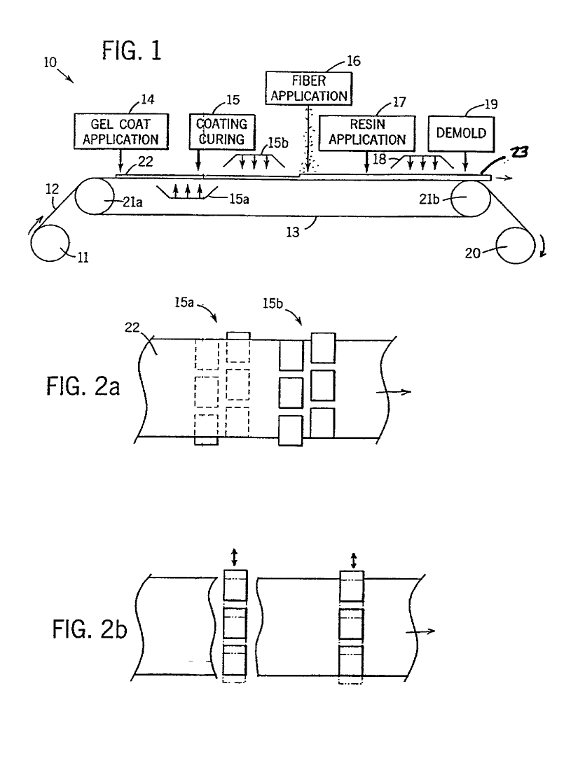

One embodiment of the process of this invention is further described with reference to FIGS. 1 and 2. In these and the other figures, like numerals are used to designate like parts. As shown, a production line 10 comprises roll dispenser 11 carrying a roll of casting film 12 which comprises any plastic film transparent to the curing actinic radiation, an optional endless belt 13 (which is also transparent to the curing actinic radiation), a gel coat resin application station 14, a gel coat resin curing station 15, a fiber application station 16, a resin application station 17, a laminate curing station 18, a demolding station 19, a take-up reel 20 and conveyor rollers 21a and 21b. In a preferred embodiment of this invention, the plastic film and optional endless belt comprise a clear polyester, such as the film manufactured and sold by E I du Pont de Nemours Company under the trademark Mylar®. The casting film is typically of a thickness between about 5 mils and 25 mils. The optional endless belt is constructed in such a manner that it can perform its function as a support for the film throughout an extended production run. In alternative embodiments, the endless belt is replaced with a supporting glass or other actinic radiation transparent plate or with a means for maintaining the casting film taunt as it passes from roll dispenser 11 to take-up reel 20, e.g. one or more nip rolls that draw the casting film from dispenser 11 and feed it to take-up reel 20.

Casting film 12 is applied to belt 13 at roller 21 a and conveyed as a continuous ribbon to gel coat resin application station 14 at which gel coat 22 is sprayed or otherwise deposited onto one surface of casting film 12 at a thickness of about 5 to about 15 mil, preferably between about 7 and 10 mil. The gel coat at this point is a complete formulation including any initiators and other additives. The optional belt is continuously circulated about rollers 21a and 21b by a drive means, e.g., an electric motor (not shown).

The casting film bearing a substantially uniform thickness of the gel coat is then passed between a series of sources of actinic radiation. In the preferred embodiment in which the actinic radiation is UV light, the sources are an array of mercury vapor lamps 15a and 15b positioned below and above the casting film respectively. The lamps are adjusted such that those over the surface of the casting film bearing the gel coat emit UV radiation directly onto the gel coat while those beneath the surface of the casting film emit UV radiation onto the gel coat only after the UV radiation has passed through the casting film. These lamps are positioned so that the cure is bidirectional, i.e., the gel coat is cured simultaneously or near simultaneously from both its surfaces. A sufficient number of lamps are deployed between station 15 and fiber application station 16 that the gel coat is at least partially, preferably fully, cured.

The lamps are arrayed such that the entire surface of the gel coat is exposed to a curing amount of actinic radiation, e.g., the staggered array depicted in FIG. 2a. In another embodiment FIG. 2b, the lamps are moveable relative to the gel coat such that they sweep across the gel coat as it moves above and/or below them. In this embodiment, the full area of the gel coat is covered with actinic radiation without the need for a second array of lamps staggered relative to the first array so as to cover those areas of the gel coat not covered by the first array of lamps. As here used, a curing amount of actinic radiation means sufficient actinic radiation to effect at least a partial cure (tacky to the touch), preferably a full cure, within the time that the gel coat is exposed to the radiation.

Although simultaneous, bidirectional cure is one embodiment of this invention, preferably the cure of the gel coat is initiated through the casting film such that a cure gradient is established in the gel coat before cure is begun at the exposed surface of the gel coat. In the embodiment of this invention in which the cure of the gel coat is begun simultaneously through the casting film and at the exposed surface of the gel coat, either the cure that is initiated through the casting film is of sufficient intensity (relative to the cure begun at the exposed gel coat surface) or the cure that is initiated at the exposed surface of the gel coat is inhibited (e.g., through exposure to oxygen), or both, such that a cure gradient is established from casting film to the exposed gel coat surface. Once the gel coat is cured, it can either be collected (e.g., onto a take-up reel) for transport and/or storage, used in an application (e.g., applied immediately to a substrate), or further processed (e.g., laminated to a reinforced polymer matrix as depicted in FIG. 1).

Several methods are known for laminating a reinforced polymer matrix to a cured or partly cured gel coat. One method, not shown, is simply to overlay a preformed reinforced polymer matrix onto a cured or partly cured gel coat. Another method is shown in FIG. 1, i.e., to construct the reinforced polymer matrix on the gel coat as part of a single production line. In this method, fibers 16a are applied to the exposed surface of cured (or partially cured) gel coat 22. Fibers 16a are applied at any desirable thickness in a uniform manner. The fibers can be subjected to a pressing means (not shown) to promote a uniform thickness across the width of the gel coat prior to the application of additional resin at station 17. The additional resin can be, and typically is, the same as the gel coat resin although it can also be a different resin. It too is a complete formulation including any initiators and other additives.

The fiber-bearing, resin-wetted, at least partially cured gel coat is then passed to laminate curing station 18 at which it is exposed to a curing amount of actinic, e.g., UV mercury lamps 18a, radiation. Laminate 23 is then passed to demolding station 19 at which the laminate is removed from the belt and the casting film is collected onto take-up reel 20 for eventual re-use.

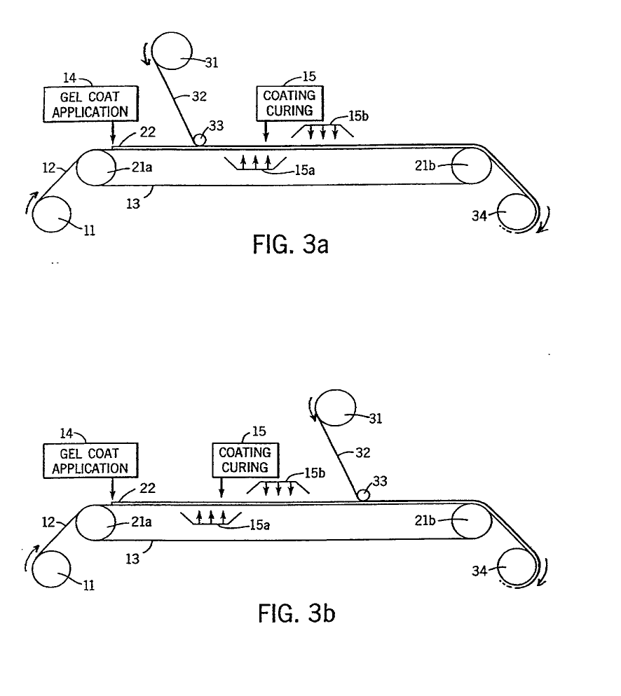

FIG. 3a illustrates a production line employing a bi-directional cure of a gel coat that is sandwiched between two nonporous, transparent films and collected on a take-up roll. As described in FIG. 1, casting film 12 is applied to optional belt 13 at roller 21a and conveyed as a continuous ribbon to gel coat resin application station 14 at which gel coat 22 is sprayed or otherwise deposited onto one surface of casting film 12 at a thickness of about 5 to about 15 mil, preferably between about 7 and 10 mil. The gel coat at this point is a complete formulation including any initiators and other additives. The belt is continuously circulated about rollers 21a and 21b by a drive means, e.g., an electric motor (not shown).

The process of FIG. 3a, however, differs (among other ways) from the process of FIG. 1 in that rather than moving directly to cure station 15, the uncured gel coat is overlayed with second casting or cover film 32 from reel 31 at roller 33. The overlay gel coat is then moved to cure station 15 and subsequently collected on take-up reel 34. Gel coats prepared in this manner store well over time and for certain formulations, e.g., acrylics, promote a faster preparation time because the overlay casting film reduces the influence of oxygen inhibition to the cure. However, the gel coat is at least partially cured (usually to the extent that the surface overlayed with the casting film is tacky to the touch when the overlay casting film is delaminated from the gel coat). The cure of the gel coat is then completed either prior to or after application of the gel coat to its ultimate substrate.

FIG. 3b illustrates a variant on the production line of FIG. 3a. Here too, casting film 12 is applied to optional endless belt 13 and the gel coat is applied to the casting film in the same manner that both are applied in FIGS. 1 and 3a but unlike the process described in FIG. 3a, overlay casting film 32 is applied to the gel coat after cure station 15. Here, preferably the gel coated is fully cured. Gel coats prepared in this manner are well suited for storage and for use in applications in which they are laminated to a reinforcing polymer matrix. In one embodiment of this invention, casting film 32 is soluble in the resin used to make the reinforcing polymer matrix, e.g., casting film 32 comprises polystyrene which is soluble in styrene or a surface veil (e.g., silica glass). This allows for omitting the step of removing the overlay casting film from the gel coat prior to applying the gel coat to its ultimate end use.

The gel coats produced by the process of this invention are used in conventional manners. In the case of the gel coat in roll form sandwiched between two transparent films, e.g., as produced by the process described in FIG. 3a, (i) the roll is unwound onto a flat or contoured surface in the shape of the desired molded composite, (ii) the overlay casting film (film 32 in FIG. 3a) is delaminated, (iii) and the exposed surface of the gel coat is laminated with or to a substrate. The bottom or supporting nonporous, transparent casting film (film 12 in FIG. 3a) is delaminated from the top (cosmetic or exposed) surface of the gel coat once the laminate is at least partially cured.

As for the gel coat roll containing the transparent casting film on one side and the resin-soluble film on the opposite side (e.g., as produced by the process described in FIG. 3b), fabrication of a composite is similar to the process described for the gel coat produced by the process described in FIG. 3a except that only the supporting casting film (film 12 in FIG. 3b) must be delaminated following at least partial cure of the composite. The overlay casting film (film 32 in FIG. 3b) side of the gel coat is applied (with or without an adhesive) to the substrate to be coated or laminated, and the overlay casting film eventually dissolves in the resin of the polymer matrix. The fully cured gel coat does not adhere strongly, however, to the supporting casting film and as such, the supporting casting film is easily delaminated from the fully cured gel coat. Once applied to the substrate, the exposed surface of the gel coat is that surface which was adjacent to the casting film and as such, it is essentially defect-free.

The following examples are illustrative of certain embodiments of this invention. Unless stated to the contrary, all parts and percentages are by weight.

### EXAMPLE 1

### Comparative

Urethane acrylic, UV-curable pigmented gel coat was initiated with one percent (1%) Irgacure® 819, a bisacylphosphine oxide from Ciba Specialty Chemicals. The photoinitiator was blended with styrene at a 1:3 ratio. The gel coat was sprayed onto a 14 inch×14 inch, 10 mil plastic film and drawn down (draw down bar was 9 inches wide) to a thickness of 23 mils.

Using the Honle UVASPOT 400/T with a metal halide bulb, the gel coat was exposed from the top side only with a lamp distance of 5 inches and a line speed of 12 feet per minute (fpm). The film was exposed a second time under the same conditions.

Warpage was measured by placing the 14×14 plastic film with the cured gel coat on a flat surface and measuring the distance from the surface to the edge of the plastic film.

The gel coat was then laminated with dicyclopentadiene laminating resin and 3

plies of 1.5 ounces glass and 1.5% methyl ethyl ketone peroxide. Once the resin was fully cured, part of it was delaminated and inspected. The gel coat had a dense, subsurface porosity with craters measuring up to 0.3 mm in diameter. Warpage was low, i.e., 1 inch, the panel had an initial 60° gloss value of 89 (a good value), and it did not exhibit alligatoring.

### EXAMPLE 2

### Invention

Example 1 was repeated except that the gel coat was exposed from the bottom side only with a lamp distance of 3 and a line speed of 12 fpm. The gel coat had a dense, subsurface porosity with craters measuring up to 0.2 mm in diameter. Warpage was significant, i.e., 4 inches, the panel had an initial 60° gloss value of 89, and it did not exhibit alligatoring.

While relatively small, this example does report an improvement over Example 1 in regards to porosity. It also reports an improvement over Example 1 in gloss. This is because the coating of this example received much more light near the mold than the coating in Example 1. This, however, resulted in increased warpage (due to the force imbalance which occured when the resin shrank during cure).

### EXAMPLE 3

### Invention

Example 1 was repeated except that the gel coat was exposed first from the bottom side (lamp distance of 3) and then from the top side (lamp distance of 5) with a line speed of 12 fpm. The gel coat had a dense, subsurface porosity with craters measuring up to 0.1 mm in diameter. Warpage was low, i.e., 1 inch, the panel had an initial 60° gloss value of 90, and it did not exhibit alligatoring.

### EXAMPLE 4

### Comparative

Example 1 was repeated except that the acrylic resin was replaced with an isophthalic polyester resin, and the curing sequence was two exposures at a line speed of 15 fpm, followed by two exposures at 5 fpm, followed by two exposures at 2 fpm. The gel coat did not exhibit any porosity, but it did exhibit alligatoring. The gel coat also exhibited low warpage of 0.5, and it had a initial 60° gloss value of 97.

### EXAMPLE 5

### Invention

Example 4 was repeated except that the gel coat was exposed from the bottom side only at a lamp distance of 3. The gel coat did not exhibit any porosity, but it did exhibit alligatoring. The gel coat also exhibited low warpage of 0.25, and it had a initial 60° gloss value of 89.

### EXAMPLE 6

### Invention

Example 4 was repeated except that the gel coat was exposed first from the bottom side (lamp distance of 3) and then from the top side (lamp distance of 5) with a line speed of 12 fpm. The gel coat did not exhibit any porosity, alligatoring or warpage. It had an initial 60° gloss value of 94.

### EXAMPLE 7

### Comparative

Example 1 was repeated except that the urethane acrylic resin was replaced with a 25:75 blend of a urethane acrylic resin and an isophthalic polyester resin, and the line speed was 10 fpm. The gel coat did not exhibit any porosity, warpage or alligatoring. The gel coat had an initial 60° gloss value of 60.

### EXAMPLE 8

### Invention

Example 7 was repeated except that the gel coat was exposed from the bottom side only with a lamp distance of 3 and a line speed of 10 fpm. The gel coat did not exhibit any porosity, warpage or alligatoring. The gel coat had an initial 60° gloss value of 94.

### EXAMPLE 9

### Invention

Example 7 was repeated except that the gel coat was exposed first from the bottom side (lamp distance of 3) and then from the top side (lamp distance of 5) at a line speed of 10 fpm. The gel coat did not exhibit any porosity, warpage or alligatoring. The gel coat had an initial 60° gloss value of 96.

### EXAMPLE 10

### Invention

A 25:75 blend of urethane acrylate and isophthalic polyester resin, UV-curable pigmented gel coat was initiated with one percent (1%) Irgacure® 819, a bisacylphosphine oxide from Ciba Specialty Chemicals. The photoinitiator was blended with styrene at a 1:3 ratio. The gel coat was sprayed onto a 14×23, 7 mil plastic film and drawn down (draw down bar was 9 inches wide) to a thickness of 15 mils.

Using the Honle UVASPOT 400/T with a metal halide bulb, the gel coat was exposed one time from the bottom side (lamp distance of 3) followed by one time from the top side (lamp distance of 5) at a line speed of 10 fpm. After cure, a 10 mil e-glass surface veil from Elk Corporation was applied to the top of the gel coat, and then the gel coat was made into a roll. After three days, the gel coated was unrolled and laminated with dicyclopentadiene laminating resin and 3 plies of 1.5 ounces of glass and 1.5% methyl ethyl ketone peroxide. Once the resin was fully cured, the gel coat was delaminated and certain of its physical properties were measured. The gel coat did not exhibit any porosity, alligatoring or warpage, and it had an initial 60° gloss value of 94.

### EXAMPLE 11

### Invention

Example 10 was repeated except that a 7 mil Mylar film was applied to the top of the cured gel coat. The gel coat did not exhibit any porosity, alligatoring or warpage, and it had an initial 60° gloss value of 90.

### EXAMPLE 12

### Invention

Example 10 was repeated except that a 10 mil polystyrene film was applied to the top of the cured gel coat. The gel coat did not exhibit any porosity, alligatoring or warpage, and it had an initial 60° gloss value of 92.

Examples 3, 6 and 9 demonstrate the benefit of the preferred embodiment of bi-directional curing. Each of these examples exhibit some performance benefit in terms of gloss, porosity size reduction, warpage reduction and/or the absence of alligatoring relative to the mono-directional cure examples of the same coating formulations that precede them.

While this invention has been described in considerable detail by the proceeding examples, this detail is provided for the purpose of illustration only and is not to be construed as a limitation upon the invention as described in the following claims.

1. A bi-directional curing process for preparing an at least partially cured, essentially nonporous, low warpage gel coat, the process comprising the steps of:
A. Applying an uncured gel coat to a nonporous mold, the mold at least partially transparent to actinic radiation, the uncured gel coat (i) comprising a polymeric composition that cures upon exposure to actinic radiation, and (ii) having a first surface in contact with a surface of the nonporous mold, and a second surface opposite the first surface and open to the environment;
B. Exposing the first surface of the uncured gel coat to actinic radiation from a first source, the first source located such that the actinic radiation must pass through the nonporous mold to effect an at least partial cure of the gel coat; and
C. Simultaneously or shortly following step (B), exposing the second surface of the gel coat to actinic radiation from a second source, the second source of the actinic radiation located such that the actinic radiation does not pass through the nonporous mold to effect the at least partial cure of the gel coat.

2. The process of claim 1 in which the mold is a casting plastic film.

3. The process of claim 2 in which the casting plastic film comprises a polyester resin.

4. The process of claim 2 in which the actinic radiation is at least one of infrared, visible and ultraviolet light radiation.

5. The process of claim 2 in which the actinic radiation comprises ultraviolet light.

6. The process of claim 5 in which both the first and second sources of ultraviolet light are mercury lamps.

7. The process of claim 6 in which the first mercury lamps are located beneath the film and the second mercury lamps are located above the film and downstream of the first mercury lamps.

8. The process of claim 1 in which the gel coat comprises a resin selected from the group consisting of an acrylic resin, an unsaturated polyester resin and mixtures of an acrylic resin and an unsaturated polyester resin.

9. The process of claim 7 in which the gel coat comprises a resin selected from the group consisting of an acrylic resin, an unsaturated polyester resin and mixtures of an acrylic resin and an unsaturated polyester resin.

10. The process of claim 7 comprising the additional step of applying a reinforcing lamination to the second surface of the at least partially cured gel coat, the reinforcing lamination (i) comprising a resin in combination with a reinforcing fiber, and (ii) having a first surface in intimate contact with the second surface of the at least partially cured gel coat and a second surface opposite the first surface and open to the environment.

11. The process of claim 10 in which the resin of the reinforcing lamination comprises the same resin as the gel coat and the reinforcing fiber is at least one of fiberglass or a plastic.

12. The process of claim 10 comprising the additional step of exposing the second surface of the reinforcing laminate to actinic radiation from a third source, the third source located above the second surface of the laminate and downstream of the second source of actinic radiation.

13. The process of claim 12 comprising the additional step of overlaying the reinforcing lamination with a cover plastic film.

14. The process of claim 13 in which the cover plastic film is of the same composition as the casting plastic film.

15. The process of claim 12 comprising the additional step of overlaying the reinforcing laminate with a cover plastic film that is at least partially transparent to actinic radiation prior to exposing through the cover plastic film the second surface of the reinforcing laminate to actinic radiation from the third source.

16. The process of claim 7 comprising the additional step of overlaying the gel coat with a cover plastic film that is at least partially transparent to actinic radiation before exposing the gel coat to the first source of actinic radiation.

17. The process of claim 7 comprising the additional step of overlaying the at least partially cured gel coat with a cover plastic film that is soluble in the reinforcing resin prior to cure.

18. The process of claim 17 comprising the additional step of collecting the at least partially cured gel coat onto a take-up reel.

19. The process of claim 16 comprising the additional step of collecting the at least partially cured gel coat onto a take-up reel.

20. An essentially nonporous, at least partially cured gel coat as prepared by the process of claim 1.

21. An essentially nonporous, at least partially cured gel coat as prepared by the process of claim 10.

22. An essentially nonporous, at least partially cured gel coat as prepared by the process of claim 15.

23. An essentially nonporous, at least partially cured gel coat as prepared by the process of claim 16.

24. An essentially nonporous, at least partially cured gel coat as prepared by the process of claim 17.

25. An essentially nonporous, at least partially cured gel coat as prepared by the process of claim 18.

26. An essentially nonporous, at least partially cured gel coat as prepared by the process of claim 19.

27. A process for preparing an at least partially cured, essentially nonporous gel coat, the process comprising the steps of:
A. Applying an uncured gel coat to a nonporous mold, the mold at least partially transparent to actinic radiation, the uncured gel coat (i) comprising a polymeric composition that cures upon exposure to actinic radiation, an d (ii) having a first surface in contact with a surface of the nonporous mold, and a second surface opposite the first surface and open to the environment; and
B. Exposing the first surface of the uncured gel coat to actinic radiation from a source located such that the actinic radiation must pass through the nonporous mold to effect an at least partial cure of the gel coat.

28. The process of claim 27 in which the mold is a plastic film.

29. The process of claim 28 in which the plastic film comprises a polyester resin.

30. The process of claim 28 in which the actinic radiation is at least one of infrared, visible and ultraviolet light radiation.

31. The process of claim 30 in which the actinic radiation comprises ultraviolet light.

32. The process of claim 27 in which the uncured gel coat comprises a resin selected from the group consisting of an acrylic resin, an unsaturated polyester resin and mixtures of an acrylic resin and an unsaturated polyester resin.

33. An essentially nonporous, at least partially cured gel coat as prepared by the process of claim 27.

34. The process of claim 1 in which the cure of the gel coat is augmented with thermal energy.

35. The process of claim 27 in which the cure of the gel coat is augmented with thermal energy.
